(19) United States
(12) Patent Application Publication
(10) Pub. No.: US 2012/0033750 A1
(43) Pub. Date: Feb. 9, 2012

(54) TRANSPORT BLOCK SIZE

(75) Inventor: Neda Nikaein, Antibes (FR)

(73) Assignee: ICERA INC., Wilmington, DE (US)

(21) Appl. No.: 13/196,752

(22) Filed: Aug. 2, 2011

(30) Foreign Application Priority Data
Aug. 3, 2010 (GB) 1013039.1

(51) Int. Cl. H04L 27/28

(52) U.S. Cl. 375/260

(57) ABSTRACT

Disclosed herein is a method, device, network and computer program product for transmitting data in transport blocks from the device on an uplink channel of the network. Information indicative of a current condition on the uplink channel is determined. Based on the determined information, a transport block size for use in transmitting data on the uplink channel is adapted and data is transmitted from the device on the uplink channel in transport blocks having the adapted transport block size.

### CROSS-REFERENCE TO RELATED APPLICATION

This application claims the benefit of GB Application No. 1013039.1 filed on Aug. 3, 2010, entitled “TRANSPORT BLOCK SIZE, commonly assigned with this application and incorporated herein by reference.

### TECHNICAL FIELD

The present invention relates to the transport block size used for transmission of data on an uplink channel. In particular, the present invention relates to adapting the transport block size.

### BACKGROUND

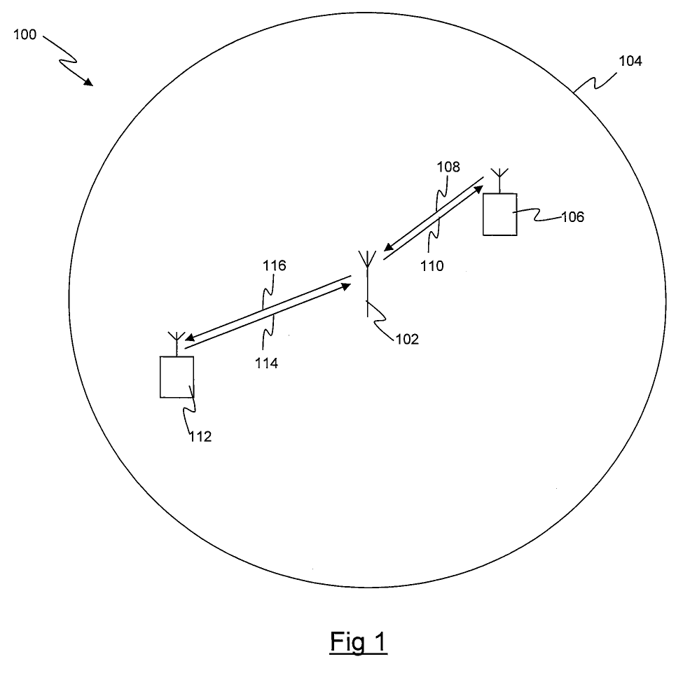

FIG. 1 illustrates a cell 104 which is a part of a communication network 100. A Node-B 102 can communicate with user equipment (UE) present in the cell 104. FIG. 1 shows, as an example, two UEs 106 and 112 present in the cell 104, but there may be many more UEs present in the cell at any one time, as would be apparent to a person skilled in the art. The Node-B 102 can send data to UE 106 on a downlink channel 110 and can receive data from UE 106 on an uplink channel 108. Similarly, the Node-B 102 can send data to UE 112 on a downlink channel 116 and can receive data from UE 112 on an uplink channel 114. The communication channels between the Node-B 102 and the UEs in the cell 104 may be enhanced dedicated channels (E-DCHs) in uplink.

Data is grouped together into transport blocks for transmission over the channels in the network 100. The amount of data that can be transmitted over a channel depends upon the size of the transport blocks used to transmit the data. The transport block sizes used on the various channels in cell 104 can be controlled by the Node-B 102.

A reference channel exists on the downlink (e.g. from the Node-B 102 to UE 106 ), and the quality of data received on the reference channel can be used to determine conditions on the downlink channel 110. The information regarding the conditions on the downlink channel can be used at the Node-B 102 to adapt the transport block size used for transmission of data on the downlink channel 110 to suit the current downlink channel conditions.

However, on the uplink (e.g. from UE 106 to the Node-B 102) there is no reference channel. A scheduler in the Node-B 102 uses information received from each UE in the cell 104 to allocate a grant which sets a maximum power that can be used by each UE for transmitting data on the uplink channels. For example, the grant may be expressed as a maximum allowed power ratio of the E-DCH Dedicated Physical Data Channel (EDPDCH) and the Dedicated Physical Control Channel (DPCCH).

When UE 106 receives a grant from the Node-B 102 it then has knowledge of the maximum power limit it has at its disposal for transmitting data on the uplink channel 108. Based on this knowledge, the UE 106 can then autonomously select the maximum transport block size for which the required transmission power is not higher than the allocated grant. In this way the Node-B 102 can control the size of the transport blocks used in the uplink as well as in the downlink.

The information sent from the UEs to the Node-B 102 in order for the Node-B 102 to allocate the grants comprises (i) the Total E-DCH Buffer Status (TEBS) which provides information on the amount of data at the UE waiting to be transmitted on the uplink channel, and (ii) the UE power headroom (UPH). The scheduler in the Node-B 102 allocates the grants to the UEs in such a way as to reduce the amount of interference in the cell 104 whilst also taking into account the information received from the UEs.

SUMMARY

According to a first aspect of the invention there is provided a method of transmitting data in transport blocks from a device on an uplink channel of a network, the method comprising: determining information indicative of a current condition on the uplink channel; based on the determined information, adapting a transport block size for use in transmitting data on the uplink channel; and transmitting data from the device on the uplink channel in transport blocks having the adapted transport block size.

According to a second aspect of the invention there is provided a device for transmitting data in transport blocks on an uplink channel of a network, the device comprising: determining means for determining information indicative of a current condition on the uplink channel; adapting means for adapting, based on the determined information, a transport block size for use in transmitting data on the uplink channel; and transmitting means for transmitting data on the uplink channel in transport blocks having the adapted transport block size.

According to a third aspect of the invention there is provided a network comprising: a device for transmitting data in transport blocks on an uplink channel of the network; and a node for receiving the transmitted data on the uplink channel. The device includes: determining means for determining information indicative of a current condition on the uplink channel; adapting means for adapting, based on the determined information, a transport block size for use in transmitting data on the uplink channel; and transmitting means for transmitting data on the uplink channel in transport blocks having the adapted transport block size.

According to a fourth aspect of the invention there is provided a computer program product comprising computer readable instructions for execution by computer processing means at a device for transmitting data in transport blocks from the device on an uplink channel of a network, the instructions comprising instructions for: determining information indicative of a current condition on the uplink channel; based on the determined information, adapting a transport block size for use in transmitting data on the uplink channel; and transmitting data on the uplink channel in transport blocks having the adapted transport block size.

### BRIEF DESCRIPTION

For a better understanding of the present invention and to show how the same may be put into effect, reference will now be made, by way of example, to the following drawings in which:

FIG. 1 is a schematic representation of an embodiment of a cell of a communication network constructed according to principles of the disclosure;

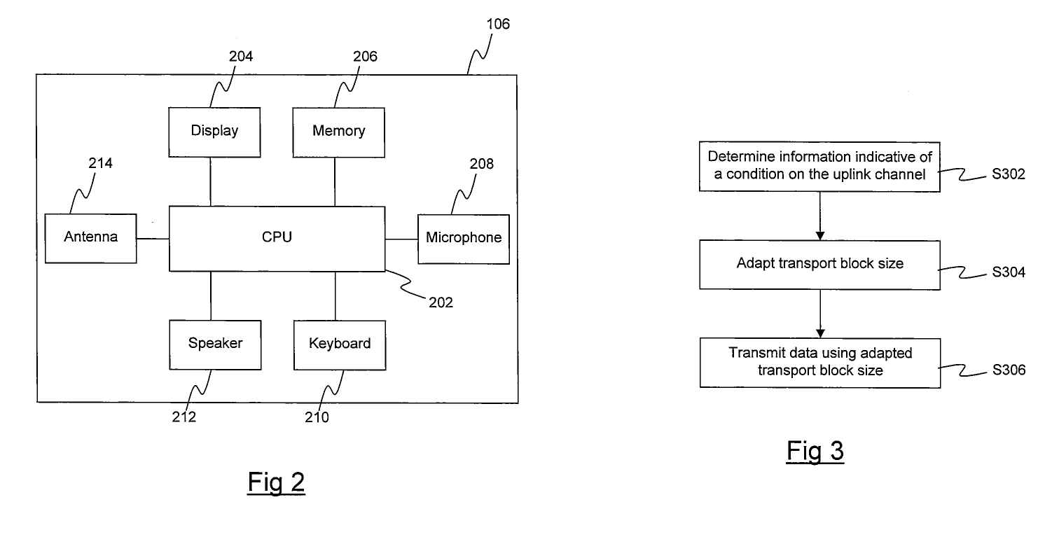

FIG. 2 is a block diagram representing an embodiment of user equipment constructed according to the principles of the disclosure; and

FIG. 3 is a flow chart for an embodiment of a process of transmitting data from user equipment carried out according to the principles of the disclosure.

### DETAILED DESCRIPTION

The disclosure realizes that the prior art does not take account of channel dependent information in determining the transport block size to be used on an uplink channel. Furthermore, the disclosure realizes that it can be beneficial to determine the transport block sizes for use on an uplink channel at the UE itself. The Node B should still fix the maximum grant or the maximum transport block size as it is the only entity in the cell having the knowledge of the interference level of all UEs in the cell. However, the UE 106 can decide to use a smaller transport block than that set by the grant in order to improve throughput on the uplink channel 108 in bad radio conditions.

The disclosure realizes that by adapting the transport block size according to a current condition on the uplink channel, the throughput of data on the uplink channel can be improved. In particular, when channel conditions on the uplink are good, it may be preferable to use a relatively large transport block size on the uplink channel which will increase the rate of data transfer (and thereby the throughput of data) over the uplink channel. However, when channel conditions on the uplink are bad, it may be preferable to use a relatively small transport block size, such that the loss of a transport block during transmission over the uplink channel has a smaller effect on the throughput of the data on the uplink channel.

Provided herein is a device for transmitting data in transport blocks on an uplink channel of a network according to the principles of the disclosure. In some embodiments, the device is a UE in a communication network. The data transmitted from the UE may, for example, be modulated using a quadrature amplitude modulation (QAM) scheme, such as a 16-QAM modulation scheme.

The UE may transmit data to a Node-B over the uplink channel. The UE may determine the number of Hybrid Automatic Repeat Request (HARQ) retransmissions transmitted on the uplink channel as a measure of the current condition on the uplink channel. Hybrid Automatic Repeat Request (HARQ) is a variation of the Automatic Repeat Request (ARQ) error-control method. In standard ARQ, error detection bits (such as cyclic redundancy check (CRC) bits) are added to data to be transmitted. In Hybrid ARQ, forward error correction (FEC) bits (such as Reed-Solomon code or Turbo code) are also added to the existing error detection bits and the combination of FEC bits and error correction bits can be referred to as “error correction code”. In the HARQ method both error detection bits and FEC bits are transmitted. When a coded data block is received, the receiver decodes the error correction code. If the channel quality is good enough, all transmission errors are correctable, and the receiver can obtain the correct data block. If the channel quality is bad, and not all transmission errors can be corrected, the receiver will detect this situation using the error detection code, then the received coded data block is discarded and a retransmission of the data block is requested by the receiver, similar to ARQ. In this sense, the receiver sends either a positive acknowledgement message (ACK) to the transmitter indicating that the data has been received correctly or a negative acknowledgment message (NACK) to the transmitter indicating that the data cannot be recovered at the receiver and that the transmitter should retransmit the data.

The disclosure realizes that a determination of the number of HARQ retransmissions that have been sent on the uplink channel provides an indication of the current condition (or quality) of the uplink channel. In some embodiments, the number of HARQ retransmissions that have been sent on the uplink channel in a time interval T can be determined at the UE for use in adapting the transport block size. Despite the absence of a reference channel on the uplink, information indicative of a current condition on the uplink channel can be provided in the form of the number of HARQ retransmissions sent over the uplink channel. In other embodiments, the UE can determine information indicative of the current condition on the uplink channel using information other than the number of HARQ retransmissions. For example, in general, the UE may receive feedback from the Node-B on the quality of data received over the uplink channel from the device. This feedback may comprise the HARQ ACK/NACK messages, or messages containing any other type of information from which the UE can determine information indicative of the current condition on the uplink channel.

It will be appreciated by those skilled in the art that by adapting the transport block size based on information indicative of a current condition on the uplink channel, the transport block size can be adapted to suit the particular conditions on the uplink channel at the time at which the data is to be transmitted. By carrying out the steps of determining the information indicative of the current condition on the uplink channel and of adapting the transport block size at the UE, the transport block size can be quickly adapted to thereby quickly respond to changes in the condition on the uplink channel. Furthermore, no extra functionality is required at the Node-B, which means that the method can be employed in a large number of UEs within one cell of the network without placing a large extra burden on the network resources. In this way, the method is well suited to scaling up with regards to the number of users in the network.

The data transmitted from the UE may, for example, be modulated using a quadrature amplitude modulation (QAM) scheme, such as a 16-QAM modulation scheme.

Embodiments of the invention will now be described by way of example only. As described above, FIG. 1 shows a cell 104 of a communications network 100 in which a Node-B 102 can transmit data on a downlink channel 110 to a user equipment (UE) 106 and can receive data on an uplink channel 108 from the UE 106. FIG. 2 is a block diagram representing functional blocks within the UE 106. Corresponding functional blocks may be present in UE 112 also. As shown in FIG. 2, UE 106 comprises a CPU 202 which is coupled to a display 204 for outputting visual data to a user of the UE 106, a memory 206 for storing data at the UE 106, a microphone 208 for receiving audio data at the UE 106 (e.g. from the user), an input device such as a keyboard 210, a speaker 212 for outputting audio data from the UE 106 (e.g. to the user) and an antenna block 214 for transmitting and receiving data to and from the Node-B 102 over the network 100. The antenna block 214 may comprise an antenna which is used for both transmission and reception of data over the network 100. Alternatively, the antenna block 214 may comprise separate antennas for transmission and reception of data over the network 100. Therefore, the UE 106 comprises the necessary components for transmitting and receiving data to and from the Node-B 102 in the network 100. The UE 106 may, for example, be a mobile phone.

As described above, data to be transmitted on the uplink channel 108 from the UE 106 to the Node-B 102 is grouped together into transport blocks for transmission, as is known in the art. Also as described above, the size of the transport blocks will affect the throughput of data on the uplink channel 108. FIG. 3 shows a flow chart for a process of transmitting data from user equipment 106 on the uplink channel 108.

In step S302 information indicative of a current condition on the uplink channel 108 is determined at the UE 106. In some embodiments, the number of HARQ retransmissions transmitted on the uplink channel 108 to the Node-B 102 in a particular time interval, T, is determined. In this way, a HARQ retransmission rate can be determined. The rate of HARQ retransmissions on the uplink channel 108 provides an indication of the current condition (or “quality”) of the uplink channel 108. It is useful to use the number (or rate) of HARQ retransmission on the uplink channel as an indication of the condition of the uplink channel 108 because for the uplink there is no reference channel which would provide a direct indication of the quality of the channel. Information indicative of a current condition on the uplink channel may be determined in step S302 in different ways to those described herein without departing from the scope of the invention.

Based on the information determined in step S302, in step S304 the transport block size is adapted in accordance with the condition on the uplink channel 108. Steps S302 and S304 may be carried out in hardware or in software in the UE 106. For example, steps S302 and S304 may be carried out by the CPU 202 of the UE 106. A value for the transport block size to be used for transmission over the uplink channel 108 may be stored in the memory 206 of the UE 106.

As described above the Node-B 102 allocates a grant to each UE in the cell 104 expressed as a maximum power ratio of EDPDCH/DPCCH. From the grant received at the UE 106 from the Node-B 102, the UE 106 has knowledge of the maximum power limit that it has at its disposal for transmission on the uplink channel 108.

The transport block size is adapted in step S304 to improve the throughput of data on the uplink channel 108 where possible. The transport block size is dynamically adapted. In this way the transport block size is adapted in real-time to suit the particular conditions currently on the uplink channel 108. This allows the transport block size to be flexible. In other words the transport block size is responsive to current conditions on the uplink channel. For example, in bad radio conditions on the uplink channel 108, the transport block size is reduced below that allowed by the grant from the Node-B 102, such that the number of HARQ retransmissions is reduced which will in turn provide an improved throughput of data on the uplink channel 108. In good radio conditions on the uplink channel 108, the transport block size is set at the maximum allowed by the grant from the Node-B 102 to thereby maximise the data rate on the uplink channel 108.

In step S306 data is transmitted on the uplink channel 108 from the UE 106 in transport blocks having the transport block size as adapted in step S304. The precise mechanism for grouping the data into transport blocks and transmitting the transport blocks on the uplink channel 108 could be performed in a number of different ways, as is known in the art.

In one embodiment, there are two modes of operation and the UE 106 uses an algorithm to determine the channel conditions on the uplink channel 108 based on the number of HARQ retransmissions (ReTx%) measured over a certain period of time T. There is a threshold (ReTx_Threshold) for the number of HARQ retransmissions measured over the period T, such that if the number of HARQ retransmissions does not exceed the threshold (i.e. if ReTx%≦ReTx_Threshold) then it is determined that there is a good radio condition on the uplink channel 108 and if the number of HARQ retransmissions exceeds the threshold (i.e. if ReTx%>ReTx_Threshold) then it is determined that there is a bad radio condition on the uplink channel 108.

When it is determined that there is a good radio condition on the uplink channel 108 then the transport block size is adapted to be the maximum size allowed by the grant from the Node-B 102. In particular, the transport block size may be in the configured Enhanced Transport Format Combination (ETFC) table, corresponding to ETFC index N. The ETFC table provides the format for use in transmitting data over the uplink channel 108, and can be referenced using the ETFC index. By referencing the ETFC table with index N the maximum transport size allowed by the grant will be obtained. However, when it is determined that there is a bad radio condition on the uplink channel 108 then the transport block size is adapted to be reduced from the maximum size allowed by the grant from the Node-B 102. In particular, the transport block size may be reduced by level L in the configured ETFC table, corresponding to ETFC index N-L. This means that by referencing the ETFC table with index N-L the reduced transport size will be obtained.

The number of HARQ retransmissions in a time interval T can be monitored on a continuous basis such that the device can switch between the two modes of operation in response to the current condition on the uplink channel 108 as appropriate.

The methods described herein have been tested for high transport block sizes (such as for Category 6 in the High Speed Uplink Packet Access (HSUPA) protocol) and have been shown to provide satisfactory results in terms of increasing throughput of data on the uplink channel 108. The values used in the algorithm for ReTx Threshold, L and T need to be tuned to optimize the throughput of data on the uplink channel 108. As well as for Category 6, the methods described herein are particularly useful for any system using high data rates on the uplink channel 108. For example, the methods described herein will be particularly useful for Category 7 with the introduction of a 16-QAM modulation scheme in the uplink.

Different categories (such as Category 6 and Category 7 mentioned above) have been defined for use by both terminals and network systems, depending on the supported features. A list of some of the already defined categories is shown in Table 1.

TABLE 1
HSUPA Categories

| Category | Maximum Speed |
|---|---|
| Cat. 1 | 0.71 Mbps |
| Cat. 2 | 1.45 Mbps |
| Cat. 3 | 1.45 Mbps |
| Cat. 4 | 2.89 Mbps |
| Cat. 5 | 2 Mbps |
| Cat. 6 | 5.74 Mbps |
| Cat. 7 | 11.5 Mbps |

As described above, in order to adapt the transport block size an indication of the conditions on the uplink channel 108 can be determined by measuring the number of HARQ retransmissions. Therefore, the indication of the conditions on the uplink channel 108 is more accurate when the uplink channel 108 is a slow fading channel. For a slow fading channel, the conditions on the channel will not significantly change over the time period T over which the number of HARQ retransmissions is determined. The methods described herein could be used for channels other than slow fading channels, but the indication of the uplink channel conditions will be more accurate for a slow fading uplink channel than for a fast fading channel.

The method performed at the UE 106 and described above for transmitting data from the UE 106 on the uplink channel 108 may be implemented by way of executing computer program instructions from a computer program product using the CPU 202 of the UE 106. The computer program product comprising the instructions can be stored in the memory 206 of the UE 106.

In the embodiments described above, the steps S302 and S304 are performed at the UE 106. In alternative embodiments, the steps S302 and/or S304 are performed at a node other than the UE 106 in the network 100. For example, the Node-B 102 could determine an indication of the condition of the uplink channel 108 in step S302. This determination could be performed at the Node-B 102 based on the number of HARQ retransmissions that are required to be sent on the uplink channel 108. Additionally or alternatively, the determination could be based on the quality of the data that is received over the uplink channel at the Node-B 102. In embodiments in which the Node-B 102 determines the uplink channel condition in step S302 then information indicative of the uplink channel condition may be transmitted to the UE 106 (e.g. on the downlink channel 110) such that the UE 106 can adapt the transport block size for use in transmitting data on the uplink channel 108. Although it is possible for the Node-B 102 to perform the determination of an indication of the uplink channel condition, this step (step S302) may be performed at the UE 106 rather than at the Node-B 102 because this eliminates the need to send extra information from the Node-B 102 to the UE 106 indicating the uplink channel condition, thereby improving the efficiency of data transfer between the Node-B 102 and the UE 106. Furthermore, by performing step S302 at the UE 106 rather than at the Node-B 102, this reduces the processing resources required at the Node-B 102 which becomes particularly beneficial when the number of UEs in the cell 104 increases.

Furthermore, in some alternative embodiments, the step of adapting the transport block size (step S304) can be performed at the Node-B 102 and the Node-B 102 can send an indication of the adapted transport block size to the UE 106 for use in transmitting data over the uplink channel 108. Alternatively, the Node-B 102 could adjust the grant that it sends to the UE 106 according to its estimated channel conditions on the uplink channel 108. However, step S304 may be performed at the UE 106 rather than at the Node-B 102 because this reduces the processing resources required at the Node-B 102 which becomes particularly beneficial when the number of UEs in the cell 104 increases.

There has therefore been described above a method and device for dynamically adapting the transport block size used on the uplink channel 108, responsive to current conditions on the uplink channel 108. It will be appreciated that by doing so, the throughput of data on the uplink channel 108 can be improved.

At least a portion of the above-described devices and disclosed methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on conventional digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods. Accordingly, computer storage products with a computer-readable medium, such as a non-transitory computer-readable medium, that have program code thereon for performing various computer-implemented operations that embody the tools or carry out the steps of the methods set forth herein may be employed. A non-transitory media includes all computer-readable media except for a transitory, propagating signal. The media and program code may be specially designed and constructed for the purposes of the disclosure, or they may be of the kind well known and available to those having skill in the computer software arts. An apparatus may be designed to include the necessary circuitry or series of operating instructions to perform each step or function of the disclosed methods.

While this invention has been particularly shown and described with reference to embodiments, it will be understood to those skilled in the art that various changes in form and detail may be made without departing from the scope of the invention as defined by the claims.

What is claimed is:

1. A method of transmitting data in transport blocks from a device on an uplink channel of a network, the method comprising:
determining information indicative of a current condition on the uplink channel;
based on the determined information, adapting a transport block size for use in transmitting data on the uplink channel; and
transmitting data from the device on the uplink channel in transport blocks having the adapted transport block size.

2. The method of claim 1 wherein the step of determining information is performed at the device.

3. The method of claim 1 wherein the step of adapting the transport block size is performed at the device.

4. The method of claim 2 wherein the step of adapting the transport block size is performed at the device.

5. The method of claim 1 wherein said step of determining information comprises determining a number of Hybrid Automatic Repeat Request retransmissions transmitted on the uplink channel.

6. The method of claim 4 wherein said step of determining information comprises determining a number of Hybrid Automatic Repeat Request retransmissions transmitted on the uplink channel.

7. The method of claim 5 wherein said step of determining information comprises determining a number of Hybrid Automatic Repeat Request retransmissions transmitted on the uplink channel during a time interval T.

8. The method of claim 6 wherein said step of determining information comprises determining a number of Hybrid Automatic Repeat Request retransmissions transmitted on the uplink channel during a time interval T.

9. The method of claim 1 wherein the transport block size is adapted between a first size for use when a first condition is present on the uplink channel and a second size for use when a second condition is present on the uplink channel.

10. The method of claim 8 wherein the transport block size is adapted between a first size for use when a first condition is present on the uplink channel and a second size for use when a second condition is present on the uplink channel.

11. The method of claim 10 wherein:
when the number of Hybrid Automatic Repeat Request retransmissions transmitted on the uplink channel during the time interval T exceeds a threshold then the transport block size is adapted to be the first size, and
when the number of Hybrid Automatic Repeat Request retransmissions transmitted on the uplink channel during the time interval T does not exceed the threshold then the transport block size is adapted to be the second size.

12. The method of claim 9 wherein the first size is less than the second size.

13. The method of claim 10 wherein the first size is less than the second size.

14. The method of claim 11 wherein the first size is less than the second size.

15. The method of claim 1 further comprising receiving a grant at the device indicating a maximum transport block size to be used on the uplink channel.

16. The method of claim 9 further comprising receiving a grant at the device indicating a maximum transport block size to be used on the uplink channel.

17. The method of claim 11 further comprising receiving a grant at the device indicating a maximum transport block size to be used on the uplink channel.

18. The method of claim 14 further comprising receiving a grant at the device indicating a maximum transport block size to be used on the uplink channel.

19. The method of claim 16 wherein the second size is equal to the indicated maximum transport block size.

20. The method of claim 17 wherein the second size is equal to the indicated maximum transport block size.

21. The method of claim 18 wherein the second size is equal to the indicated maximum transport block size.

22. The method claim 1 wherein said step of determining information comprises receiving, at the device, feedback on the quality of data received over the uplink channel from the device.

23. The method claim 18 wherein said step of determining information comprises receiving, at the device, feedback on the quality of data received over the uplink channel from the device.

24. The method of claim 22 wherein the feedback comprises positive or negative Hybrid Automatic Repeat Request acknowledgement messages.

25. The method of claim 23 wherein the feedback comprises positive or negative Hybrid Automatic Repeat Request acknowledgement messages.

26. The method of claim 1 wherein the data transmitted from the device is modulated using a 16-QAM modulation scheme.

27. The method of claim 25 wherein the data transmitted from the device is modulated using a 16-QAM modulation scheme.

28. A device for transmitting data in transport blocks on an uplink channel of a network, the device comprising:
determining means for determining information indicative of a current condition on the uplink channel;
adapting means for adapting, based on the determined information, a transport block size for use in transmitting data on the uplink channel; and
transmitting means for transmitting data on the uplink channel in transport blocks having the adapted transport block size.

29. A network comprising:
a device for transmitting data in transport blocks on an uplink channel of a network, the device comprising:
determining means for determining information indicative of a current condition on the uplink channel;
adapting means for adapting, based on the determined information, a transport block size for use in transmitting data on the uplink channel; and
transmitting means for transmitting data on the uplink channel in transport blocks having the adapted transport block size; and
a node for receiving the transmitted data on the uplink channel.

30. A computer program product comprising a non-transitory computer readable medium bearing instructions for execution by computer processing means at a device for transmitting data in transport blocks from the device on an uplink channel of a network, the instructions comprising instructions for:
determining information indicative of a current condition on the uplink channel;
based on the determined information, adapting a transport block size for use in transmitting data on the uplink channel; and
transmitting data on the uplink channel in transport blocks having the adapted transport block size.
